(19) United States
(12) Patent Application Publication
(10) Pub. No.: US 2015/0019585 A1
(43) Pub. Date: Jan. 15, 2015

(54) COLLABORATIVE SOCIAL SYSTEM FOR BUILDING AND SHARING A VAST ROBUST DATABASE OF INTERACTIVE MEDIA CONTENT

(71) Applicant: Optinera Inc., Woodside, CA (US)

(72) Inventors: Nate D'Amico, Woodside, CA (US); Vijay Chandrasekhar, Singapore (SG); Ajay Panagariya, San Francisco, CA (US); Norman Kuo, San Bruno, CA (US)

(21) Appl. No.: 14/216,773

(22) Filed: Mar. 17, 2014

Related U.S. Application Data
(60) Provisional application No. 61/786,417, filed on Mar. 15, 2013.
(60) Provisional application No. 61/786,475, filed on Mar. 15, 2013.

(51) Int. Cl. G06F 17/30

(52) U.S. Cl. CPC G06F 17/30029; G06F 17/30289
USPC 707/769

(57) ABSTRACT

A method is provided for building and sharing an electronic database of interactive media content among a community of users. An electronic submission that corresponds to an audio and/or visual media asset is received from a user. One or more fingerprints are extracted from the received submission to produce accompanying identifying data therefor, if any, that correspond to one or more assets of an interactive media database of known assets. The media asset and accompanying identification data is stored or located as an entry in a content repository for community search and access, thereby providing to the user interactive media content. When the entry is not associated with a content object, the community is allowed to create one or more content objects for the entry. Otherwise, one or more content objects are returned to the user.

### CROSS REFERENCE TO RELATED APPLICATIONS

This application claims priority to U.S. Provisional Application Ser. No. 61/786,417, entitled “Collaborative Social Platform for Building & Sharing a Vast Robust Database of Auditory Identifiable Content,” filed on Mar. 15, 2013, and to U.S. Provisional Application Ser. No. 61/786,475, entitled “Collaborative Social Platform for Building & Sharing a Vast Robust Database of Visually Identifiable Content,” filed on Mar. 15, 2013, the disclosures of which are incorporated by reference in their entireties.

### BACKGROUND OF THE INVENTION

The invention generally relates to technology that allows a community of members to build and share a database of interactive media content. In particular, the invention relates to methods and systems that allows users to store media assets and any accompanying identification data as an entry in a content repository for community search and access. The invention also allows community members to create content objects capable of linking to one or more known assets.

Crowdsourcing is the practice of obtaining needed services, ideas, or content by soliciting contributions from a large group of people, and especially from an online member community. This process may be often used to subdivide the work need to build and share a vast and robust database of content. The online encyclopedia found at wikipedia.com represents an example of what a community can achieve through crowdsourcing.

In order to efficiently build and share a database of interactive media content, a user may upload to and search for media assets in a communal content repository. Such efforts may rely heavily on automated content recognizing technologies to render media assets interactive. Automated content recognition technologies typically involve fingerprinting, a technique that detects for the presence of known media assets within a sample.

Fingerprinting involves the production of a set of compact hashes describing the “visual or audio words” of the media asset to be matched. These hashes aim to capture perceptual similarities between media assets while remaining invariant to other characteristics. For example, image fingerprinting typically involves producing hashes that are invariants to image characteristics such as color, rotation, and scale. In time-based fingerprinting, e.g., audio and/or visual fingerprinting, hashes are produced that are invariant to characteristics such as tempo and pitch. These fingerprint techniques with invariance allow for a fast lookup of matching media asset items within a very large database of known assets.

A number of problem areas exist when one wishes to build out a vast interactive media asset database. First, there is the sheer volume of media assets that exists in the world in various shapes, sizes, and locations, particularly given assets such as publications, signage, outdoor advertisements, radio, television, and etc. Issues users grapple with include, for example, the quality of the acquired asset. Asset quality is a particularly problematic issue when the asset is submitted via a mobile device. For example, images captured by a mobile device may be skewed or rotated, and audio clips may be recorded with excessive background noise.

In addition, there must be an ability to match against many types of media assets. In visual assets, for example, there exist numerous types of printed material containing with a great deal of text, sometimes mixed with images. Alternatively, an item such as signage, logos, and outdoor advertisement may be populated with sparse text. As a further example, broadcast audio based assets such as those associated with television and radio may be associated with problems such as pitch shifting. Special techniques are required to address the numerous issues that may arise during asset matching procedures.

Accordingly, opportunities exist to provide methods and systems to overcome the above-described problems to build and share a vast robust database of media content.

### SUMMARY

The invention generally relates to a method for building and sharing an electronic database of interactive media content among a community of users. The method involves receiving from a user an electronic submission that corresponds to an audio and/or visual media asset. The submission may comprise a portion or entirety of the audio and/or visual media asset. One or more fingerprints are extracted from the received submission to produce accompanying identifying data that may correspond to one or more assets of interactive media database of known assets. In some instances, one or more fingerprints may constitute the submission. Optionally, fingerprints are extracted before or as the submission is received

The method also involves the use of a content repository for community search and access. When no identifying data is produced that correspond to any known interactive asset in the database, the submission and accompanying identification data is added and stored as an entry in the content repository and interactive asset database. In addition, the community is allowed to create one or more content objects for the entry. Alternatively, when identifying data is produced that correspond to one or more assets of the database, the entry for the submission is located in the content repository, and one or more content objects for the entry is returned to the user.

For an audio media asset submission, fingerprinting may be carried out using a technique that compensates for pitch shifting that may have occurred beforehand. For a visual media asset submission, techniques appropriate for fingerprinting sparse and/or dense text may be used

In some instances, the community is allowed to create one or more content experiences that capture a collection of content objects. One or more content objects may be associated with an exclusive right to assets linked thereto. The exclusive right may be geographical and/or temporal in nature.

### BRIEF DESCRIPTION OF THE DRAWINGS

The present invention can best be understood in connection with the accompanying drawings. The invention is not limited to the precise embodiments shown in drawings, which include:

FIG. 1 is a diagram that provides a high-level overview of the inventive system.

FIG. 2 is a flow chart that provides an overview of a user may use a media search interface.

FIG. 3 is a flow chart that illustrates a media asset search and matching process.

FIG. 4 is a flow chart provides an overview of a how a user may use a content experience builder interface.

FIG. 5 is a receiver operating characteristics (ROC) plot showing retrieval results for 1, 2, 3, and 4% pitch shifting (upper left corner is most desirable).

FIG. 6 is a detection error tradeoff plot presenting the same results as shown in FIG. 5 but using logarithmic error (lower left corner is most desirable).

### DETAILED DESCRIPTION OF THE INVENTION

Definitions

Before describing the present invention in detail, it is to be understood that the invention is not limited to specific brands or types of electronic equipment, as such may vary. It is also to be understood that the terminology used herein is for describing particular embodiments only, and is not intended to be limiting.

In addition, as used in this specification and the appended claims, the singular article forms “a,” “an,” and “the” include both singular and plural referents unless the context of their usage clearly dictates otherwise. Thus, for example, reference to “fingerprint” includes a single fingerprint as well as a plurality of fingerprints, and the like.

In this specification and in the claims that follow, reference will be made to a number of terms that shall be defined to have the following meanings, unless the context in which they are employed clearly indicates otherwise:

The terms “electronic,” “electronically,” and the like are used in their ordinary sense and relate to structures, e.g., semiconductor microstructures, that provide controlled conduction of electrons or other charge carriers, e.g., holes.

The term “internet” is used herein in its ordinary sense and refers to an interconnected system of networks that connect computers around the world via the TCP/IP and/or other protocols. Unless the context of its usage clearly indicates otherwise, the term “web” is generally used in a synonymous manner with the term “internet.” The term “internet” calls forth all equipment associated therewith, e.g., microelectronic processors, memory modules, storage media such as disk drives, tape backup, and magnetic and optical media, modems, routers, etc.

The term “media asset” is used herein to refer to a computer media file, e.g., image, video, and/or audio, representing a mass media asset, e.g., a printed publication page, signage, card, poster, audio clip, song, audio advertisement, audio stream, television clip, a television song, television advertisement, and/or television stream.

The terms “media fingerprint” and “fingerprint” are interchangeably used to refer to content of a media asset that has been extracted and/or computed. A fingerprint may be represented as a set of compact hashes describing the asset in an efficient machine readable and/or searchable form.

The terms “interactive media content” and “content” are interchangeably used here to refer to media assets that have been “interactive enabled” by having their fingerprint extracted, stored and indexed in an interactive media database.

The term “metadata” as in “asset metadata” is used to describe data related to a particular media asset such as tags, description, type, geographic location, author, creator, etc.

The term “interactive media database” as used herein refers to a storage and search indexing system that holds fingerprint and metadata of media assets.

The term “media asset indexing” refers to the act or process of extracting a fingerprint and metadata from a media asset and storing in an interactive media database.

The terms “media search” and “media match” are interchangeably used herein to refer to an act performed on a media asset that involves extracting the asset's related fingerprint and associated metadata, and searching for a match against entries in a source Interactive Media Database

The term “pipeline” as in “indexing and search pipeline” refers to a sub-system in the platform that indexes and searches media assets in a particular manner using a specific process and/or types of media fingerprint and metadata

The term “content object” is used herein to refer to a structured human and machine readable data object that represents a particular described piece of asset related data. A content object may be classified according to “content object type.” Examples of “content object types” include, but are not limited to a: product; story or article; author; advertisement; universal resource locator (URL); related audio and/or video media; coupon; survey or feeback form; etc. Templates may be defined for each existing object type, which describes its various attributes and behavior.

The term “content experience” refers to a bundle of related content objects. The act of bundling content objects together allows for re-use and relation of similar or “linked” content objects. For example, content experience for a magazine story may bundle several content objects that individually represent a story, an author, an interview video, and an URL of an online version of the story.

While a content experience may be associated with a plurality of content objects, one content object may be designated as a “primary” object that lead a display of objects in a logical order to a user. For example, a user who submits a media asset of an image of a product package may be returned a content experience that contains as the primary content object for the product followed by related content objects for the product, e.g., purchase locations, ingredients, etc.

The term “linked content experience” is used to describe when an interactive media content has attached thereto one or more “linked” or associated content experiences.

The term “public domain content” refers to a default state, unless otherwise noted, for all content objects and experiences and media assets at the time of their creation.

The term “content registration” is used to describe a process which a system user wishes to take ownership and control of particular content objects, content experiences, and linked interactive media assets.

The term “user session data” is used to refer to information that is generated/gathered by the system as a system user carries out actions through the various system interfaces.

The term “user behavioral data” refers to knowledge learn from a user either via the user's interactions with the system, or by data entry on the part of the user.

System Overview

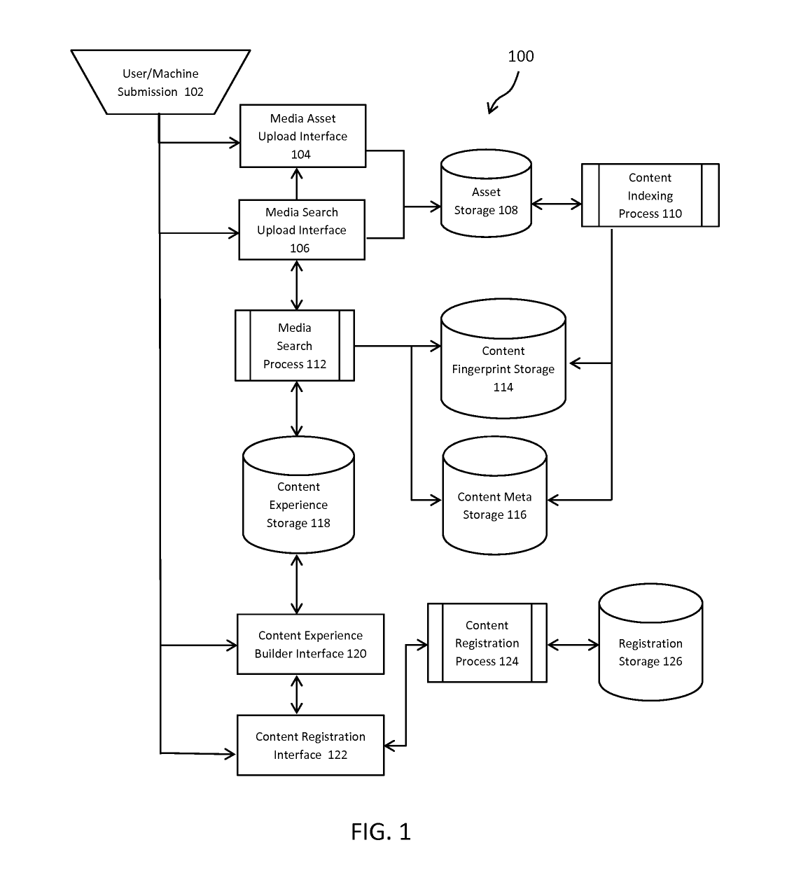

FIG. 1 provides a system overview of the inventive system. System 100 includes an upload asset interface 104, a media search upload interface 106, asset storage 108, media content indexer 110, media search process 112, content fingerprint storage 114, content meta storage 116, content experience storage 118, content experience builder interface 120, content registration interface 122, content registration process 124, and registration storage 126.

FIG. 1 also includes a user computer 102 that can call up any of the interfaces 104, 106, 120, and 122. However, a user device other than a generalized computer may be used. For example, the user device may be provided as a mobile or cellular phone, a handheld, notebook, or tablet computer. In some instance, the user device may include a camera or other optical sensor (and appropriate accompanying hardware and software) to generate optical data for transmission to the inventive system. In addition or in the alternative, the user device may include a microphone or other audio sensor to generate audio data. Furthermore, the user device may be a computer that is programmatically calling one or interfaces application programming interface (API).

In practice, the user may add media assets into the system 100 directly via the media asset upload interface 104. The media received by system is transferred to asset storage 108 and undergoes a series of analysis and indexing steps by the media content indexer 110. As a result, extracted fingerprints and metadata are sent to content fingerprint storage 114 and content meta storage 116, respectively, as an entry for community search and access. In other words, the asset in converted into interactive media content.

Alternatively, a user may introduce a media asset via the media search upload interface 106. When the media search process 112 turns up no match, fingerprints and metadata extracted from the media asset are sent to content fingerprint storage 114 and content meta storage 116, respectively. Alternatively, when a match is found, one or more media contents may be retrieved from content experience storage 118.

The content experience builder interface 120 may be used by a user to create one or more content experiences.

The content registration interface 122 may be used to allow a user to engage in a registration process 124. Once registration has occurred, a record of the registration is sent to registration storage 126.

Media Asset Indexing

The media asset indexing process represents an important aspect of the invention. In order to maintain a functioning interactive media content platform, indexing should be performed in a robust manner, regardless of the asset's origin, to ensure that proper matches will be found when a search is performed. The indexing process may also function as a means to weed out “bad” assets and/or duplicate assets.

Different optimization steps may be executed during when the media asset is indexed. Different optimization steps may be carried out for image media assets and for time-based media assets such as audio and/or video samples. Once the optimization step or steps are performed, the system runs a series of indexing pipelines in parallel. As the pipelines are run on, various media fingerprints and metadata extracted as. The fingerprints and metadata are stored and indexed for later searching/matching.

Optimization of Images with Dense Text

For image media assets comprising a photograph of a page with dense text, a robust rectifying algorithm is provided, such that the rectified text is viewed from a virtual camera viewing the text normal to the page, with the correct, upright orientation. In general, the algorithm begins by computing the vanishing points of the text. First, the horizontal vanishing point is computed. Once the image is horizontally rectified, the vertical vanishing point is computed. Finally, the image is rectified using both vanishing points.

More specifically, the algorithm may begin by computing a difference-of-Gaussian (DoG) filtered Radon transform. The DoG filter is the difference of Gaussians with standard deviations, σ and 2σ, where σ is a function of the input image size. The Radon transform is a 2D to 2D transform, wherein the transformed domain contains values corresponding to the prominence of lines in the image. The horizontal Radon axis is the line angle, and the vertical Radon axis is the line's distance from the center of the image. Therefore, as an example, a horizontal line corresponds to the Radon domain point (0, 0).

A peak in the Radon transform corresponds to a line in the image. A set of text lines, therefore correspond to a set of peaks in the Radon domain. These text lines are assumed to be horizontal and equally spaced within a paragraph. Thus, in the Radon transform of a rectified paragraph, the peaks lie along a vertical line. The horizontal position of this line of peaks in the Radon domain indicates the orientation of the page.

However, under a perspective (homography) distortion, the text lines no longer all have the same orientation. The slant of a text line becomes a function of the perspective warp strength, and the distance from the center of the image. This means that peaks in the Radon transform of a perspectively warped page will fall on a slanted line. By estimating the slope of this line, one may directly estimate the horizontal vanishing point of the image.

In other words, one may calculate a “slant transform,” a 2D to 2D mapping technique that converts a Radon transformed image into a new slant image. The slant image has values on the horizontal corresponding to the slant angle, and values on the vertical corresponding to slant offset. These (angle, offset) pairs correspond to the page orientation and perspective warp. Thus, by finding a peak in the slant transform, one may directly estimate the orientation and horizontal perspective of the text.

To compute the slant transform, the filtered Radon image is rotated in increments of Δθ. For each orientation, the variance is computed along each column of the rotated Radon image. Finally, the strongest peak is found in the slant image, and the peak's location is refined by fitting and maximizing a quadratic form.

Once the perspective and orientation of the image is known, the horizontal vanishing point may be computed. This may be done by choosing two image-lines that are members of the slanted set of radon peaks. The intersection of these two points is the horizontal vanishing point.

Given the vanishing point (in pixel homogeneous coordinates), v, and the image dimensions, w×h, homography matrix, H, ca be computed that unwarps the image. Let K be a camera calibration matrix

$$K = [ \begin{matrix}w & 0 & w \text{/} 2 \\ 0 & w & h \text{/} 2 \\ 0 & 0 & 1\end{matrix} ] .$$

Let v′ₕ=K⁻¹v be the horizontal vanishing point in retinal coordinates, and

$${v}_{v}^{l} = {R}_{\frac{π}{2}} {v}_{h}^{′}$$

be the vertical vanishing point, where

$${R}_{\frac{π}{2}} = [ \begin{matrix}0 & - 1 \\ 1 & 0\end{matrix} ] .$$

One may then compute H=[hx; hy; hz], where

$${h}_{x} = \frac{sgn ( {v}_{k , 1} )}{\sqrt{{v}_{h , 1}^{2} + {v}_{h , 2}^{2}}} {v}_{h}^{′} , \\ {h}_{y} = {R}_{\frac{π}{2}} {h}_{x} , and$$

$${h}_{x} = ( 0 , 0 , 1 ) .$$

By this point, the image has been rectified with respect to orientation and horizontal perspective. The final vertical vanishing point may be rectified by looking for paragraph edges.

First, a morphological closing operation is performed on the upright image using a purely horizontal structuring element. The purpose of this operation is to merge words in the same line. Then, regions are eliminated that are too small or too large, keeping only those that are plausible text lines. One or more lines are fitted through the left edges of the text lines, followed by the same to the right edges. To avoid boundary effects giving false lines, points that are close to the image border are culled.

Given all lines, the vanishing point may be estimated as the most plausible intersection of as many detected paragraph-edge lines as possible. The equations discussed above are used to unwarp the vertical perspective.

At this point in the algorithm, most dense text images will be properly unwarped. However, there are cases when the justified borders of a paragraph are obscured, causing the vertical vanishing point detection to fail. Thus, an alternative method may be used that relies on the spacing of peaks in the Radon transform. The alternative method is predicated on the fact that vertically rectified text will have equally spaced lines. Thus, a range of perspective warps may be applied to the horizontally rectified image, and the constancy of the inter-line spacing may be measured. The warp that yields the most constant spacing is deemed to be the correct vertical perspective correction.

The text should be rectified, except for a horizontal shear. This sheer may be corrected by fitting a line to at least one paragraph border, or by using text gradient statistics.

Optimization of Images with Sparse Text

For sparse text, the invention provides a processing pipeline for query and database images that first involves character detection. For example, one may detect bounding boxes of characters in an image using one of many known techniques. Characters are typically found as connected components of a binary image obtained from the original image.

Another detection technique involves detecting lines using multiple-hypothesis RANSAC. Centroids of bounding boxes are used to determine lines in the image. RANSAC is used for finding lines in a robust fashion. The scale of the bounding boxes (width or height) and the distance from lines are used as a criterion to determine which characters are inliers. The scale is considered because characters along a word or line roughly have the same width. The scale parameter is chosen to be robust to different orientations of the query image. This eliminates several noisy bounding boxes. Additional information pertaining to RANSAC may be found in Fischler et al. (1981), “Random Sample Consensus: A Paradigm for Model Fitting with Applications to Image Analysis and Automated Cartography” Communications of ACM, 24(6):381-395

Still another technique involves reorienting individual lines. The line orientation is used for making the text lines upright.

Yet another technique involves joint optical character recognition (OCR) and word detection In particular, OCR may be carried out on individual word lines. Words and sub-words are extracted from the line by taking into account word spelling correction, spacing between characters, and edit distance from best possible match from a stored dictionary. The different factors are considered jointly to extract words and sub-words. For the example image containing the words “maximum occupancy”, one can expect several missing characters in the character detection step based on noise in the image. The OCR output in the inventive system case would extract works like “max”, “mum”, “cup”, “pan”, “maximum”, and “occupancy” based on how many characters are missing in the first step. Example of noisy output would be “m×mum oc upotian.” For example, if the letter “a” is missing in the word “maximum”, the invention is capable of extracting words like “max” based on neighboring characters, missing characters, space between different characters and a priori dictionary. A priori space width between characters and a cost function is used for obtaining best estimates of words in each line. The bounding boxes are stored around each potential word in the line in the database.

A key advantage of the pipeline is that words are detected with OCR tightly in the detection loop, which is not the case for state-of-the-art algorithms like those described in Epshtein et al., (2010) “Detecting text in natural scenes with stroke width transform” In Proceedings of IEEE Conference on Computer Vision and Pattern Recognition (CVPR), June 2010. At the end of the processing pipeline, one may obtain a list of words in the image and locations of bounding boxes around them.

Once images are processed to extract noisy text, there are a number of ways to effect matching. The first involves pairwise matching. The invention finds how many words match between query and database images, and checks whether the words are geometrically consistent by using the locations of the bounding boxes and RANSAC with affine or similarity transform. A threshold on the number of matching words and the number of inliers in the geometric model is used to determine whether a pair of images match. Additionally, individual characters can also be used to check if the query and database images are geometrically consistent.

Another matching technique involves retrieval from a large database Retrieval is a two-step process to keep the false positive rate very low, which is desirable for visual search applications. Both words and sub-words are indexed in an Inverted File System (IFS) for fast retrieval. A ranked list of relevant images is considered for a secondary Geometric Consistency Check (GCC) as discussed previously in the pairwise matching step.

Furthermore, the invention may generate and index logical variants of the image to simulate variance such as rotation/skew/blur and index the variants in one or more of the standard image feature pipelines.

Optimization of Time-Based Assets such as Audio and Video

To address pitch shifting distortion problems in audio and visual assets, the invention provides an approach designed to increase robustness to pitch shifting distortion involves using the constant-Q transform (CQT) when computing the audio spectrogram. The CQT uses logarithmically spaced bands, which make CQT peak hashes more robust to pitch shifting. This is due to the fact that in the presence of a constant amount of pitch shifting, higher pitched components will be shifted by a greater amount in linear frequency space than lower pitched components. The reduced frequency resolution of the CQT at higher frequencies helps to compensate for this.

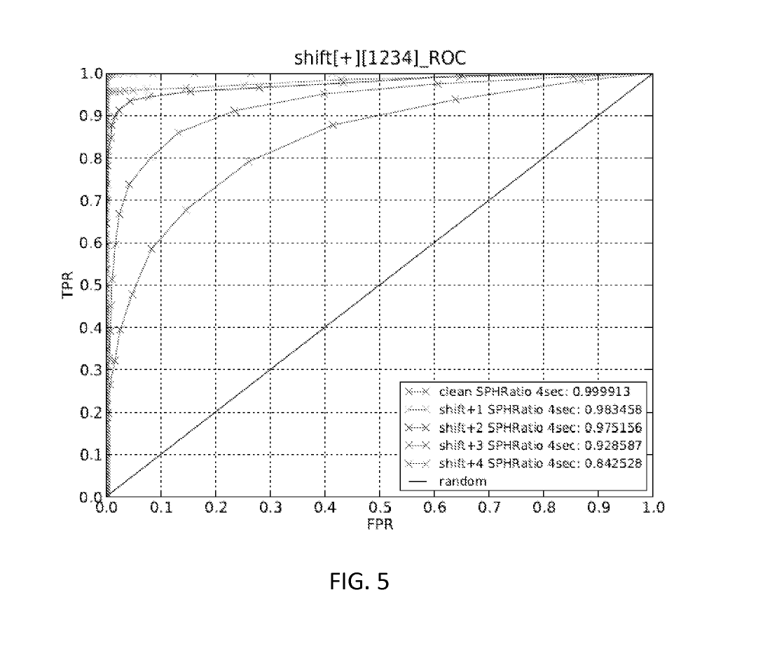

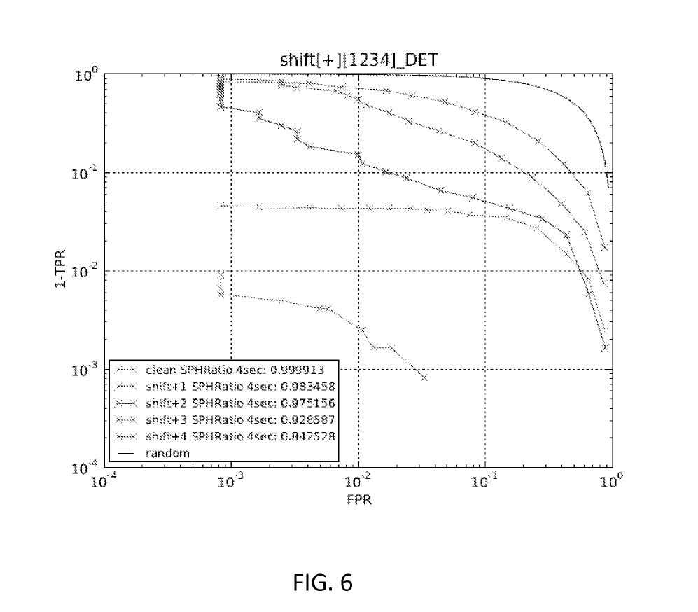

FIG. 5 shows how retrieval performance declines as increasing amounts of pitch shifting are added to the query audio. FIG. 6 gives a better overall impression of the amount of error introduced by pitch shifting. Even seemingly small amounts of error such as a 1% false positive rate become significant when working with very large databases. These results include the use of logarithmically-spaced frequency bands in order to increase robustness to pitch shifting. However, as shown in FIG. 6, the performance is greatly diminished even by the time a 2% pitch shift is reached.

While the performance achieved under 1% pitch shift distortion is considered to be acceptable for use with a large database of audio clips, greater amounts of pitch shift produce rather dismal results even when using state of the art fingerprint techniques. Therefore, the invention overcompensates on the database by storing fingerprints of pitch shifted versions of each audio clip. The linear overhead of storing additional fingerprints for each pitch shifted version is considered a reasonable tradeoff given the potential for increased retrieval performance under this common type of broadcast distortion.

Media Search

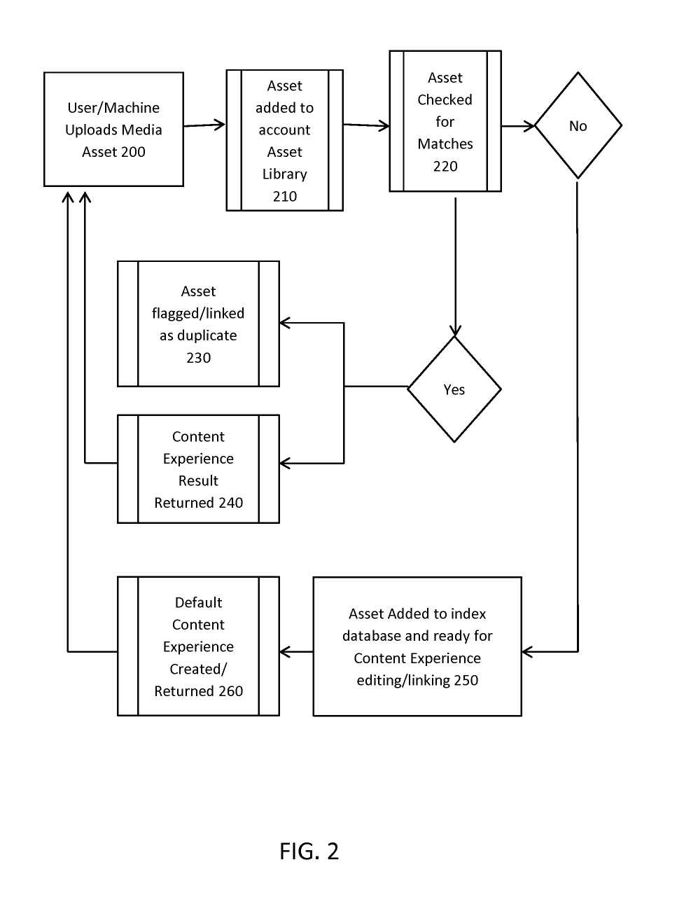

FIG. 2 provides an overview of the media search interface and process.

In step 200, the process begins when an asset is uploaded via web browser or mobile device by user. In step 210, the asset is added to an account asset library.

In step 220, the asset is checked for matches. For example, as media search is carried out, the system searches the asset against one or more matching pipelines looking for a perspective match based on the type of media asset (image, audio/video). Types of information used step 220 include, for example, uncompressed and compressed features, text that has undergone OCR, and related asset metadata content such as geographical information.

If a match is found, steps 230 and 240 are carried out.

In step 230, the system retrieves all content experiences and content metadata related to the media asset for return to the end user.

In step 240, the media asset submitted is flagged as a duplicate and be linked to the matched content record.

If no content match is found, steps 250 and 260 are carried out.

In step 250, the system adds the media asset to the interactive content database. In addition, the system sets up the content experience or object.

In step 260, a default content experience or object is returned.

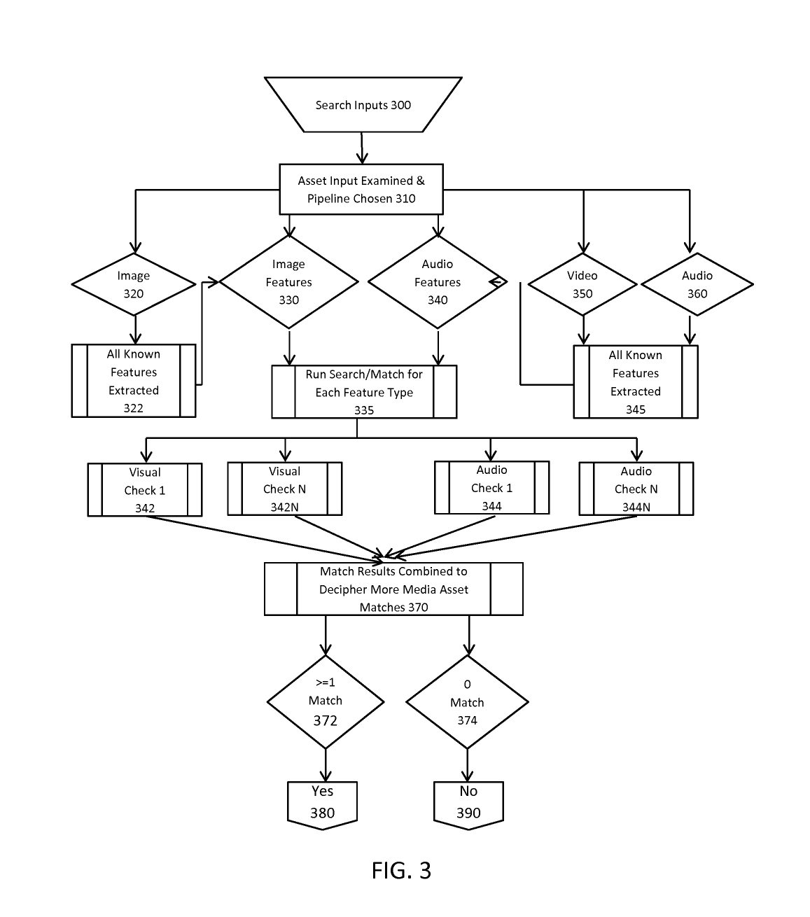

FIG. 3 depicts in greater detail the process of media asset search and matching. In general, the process can take in any of the following pieces of data: media asset file (image, video, audio); partial media asset file (e.g., asset fingerprint information or related asset metadata); geographical information (e.g., latitude and longitude) that corresponds to a location where the media asset file or partial media asset file was collected or generated; and user session and/or behavioral information corresponding to actions that the user has performed in the system previously.

In step 300, any or a combination of the above described data is received.

In step 310, the system examines the received data chooses one or typically more appropriate pipelines. One or more pipelines selected from image 320, image features 330, audio features 340, video 350, and audio 350 If, as shown in step 320, an image is received, all known features of the image is extracted in step 312 and each search/matching result is merged with step 330. Similarly, if, as shown in steps 350 and 360, video or audio is received, all known audio features may be extracted as well in step 345 and each search/matching result is merged with step 330.

In step 335, a search or match is run for each active image or audio feature/pipeline type.

For example, in each of steps 342 and 342N, visual features are checked for matches. Similarly, in each of steps 344 and 344N, audio features are checked for matches.

In step 370, match results are combined to deciphered more media asset matches. If there is one or more match found, as shown in step 372, the one or more matches are returned in step 380. Alternatively, no match is found, as shown in step 376, and the lack of matches is returned in step 390.

Content Experience Builder Interface

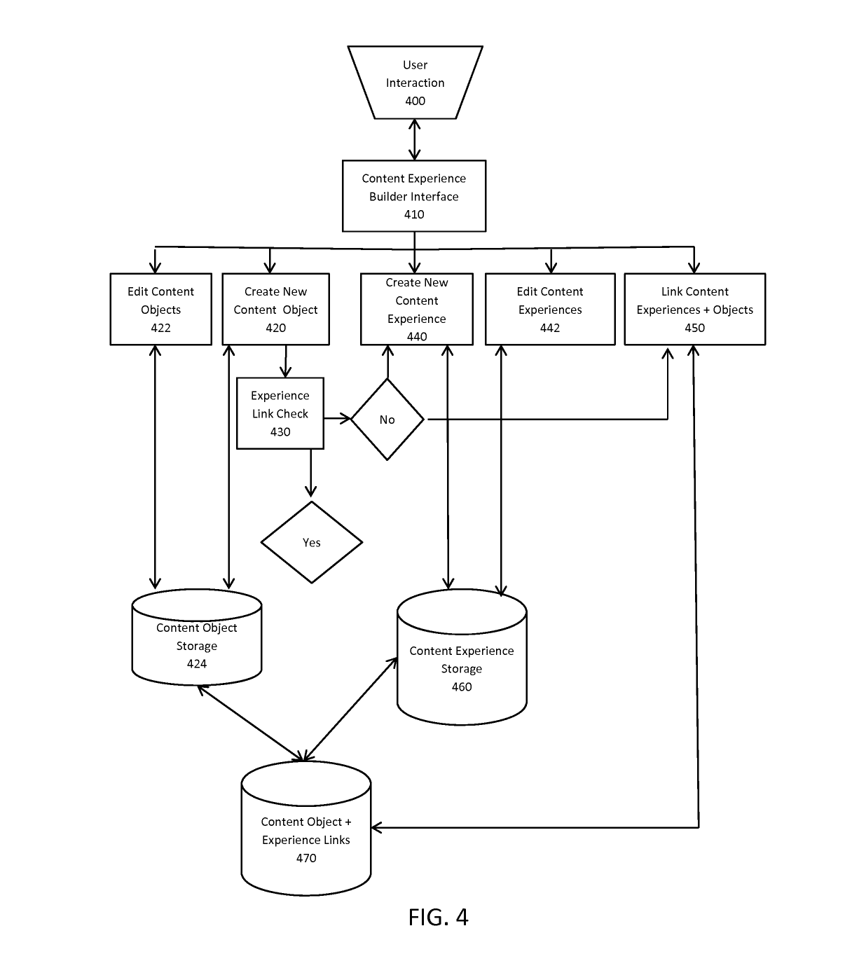

FIG. 4 provides a diagram schematically depicting an overview of the content experience builder interface. The diagram focuses on behavior where a user in step 400 is engaging with the content experience builder interface. Initially, the user creates the desired content experience and related content objects. Then, the content experience is associated with one or more items of interactive media content.

In step 410, the content experience builder interface is provided via a web application service, and/or mobile native application, and/or application programming interface. The content builder interface provides users a number of options to build and manage their content experience and related content objects.

In step 420 a new content object is created. There, the user may submit via the builder interface details for a particular object (e.g., product, URL, story, advertisement, etc.). The object is added in step 424 to content object storage. As shown in step 422, users can also edit existing content objects to update details thereof in the system.

When new content object is created, the system checks in step 430 to see whether an instructions is provided to link the content object to a particular content experience. If so, as shown in step 432, a link is provided between the new content object to the particular content experience. Otherwise, as shown in step 434, a new content experience is created. As shown in step 450, the new content object is linked to the new content experience.

As shown in step 440, users can use the builder interface to create new content experiences at any given time. Similarly, as shown in step 442, users can also edit existing content experiences to update details thereof in the system.

As shown in step 450, users who have at least one content objects and at least one content experiences in their library may link any content object with any content experience. The relationship is a many-to-many such that users can reuse content objects in various contexts and content experience use cases.

Exemplary Content Experience and Object

Generally, content experiences and content objects are at the core of the inventive system of interactive media content. Content experiences are returned to a user of the system when a media search or query is performed. That is, the system takes media asset matches, looks up all linked/related content experiences, retrieve their content from storage, and return the result to the user. Content experiences and media assets that are indexed and interactively enabled are associated at the object model level in system database storage with a many-to-many relationship. This means that an indexed media asset can have a number ranging from 0 to N of linked Content Experiences. Similarly, a content experience can be linked or associated a number ranging from to 0 to N of indexed media assets. The user could, if choosing to, link the content objects directly to the interactive media assets directly in a many-to-many relationship.

Content objects are descriptive, structured data objects that offer a number of detailed definitions. Examples of content objects types include, but are not limited to, person, author, story, URL, website, product, coupon, deal, survey form, media file (audio or visual). Content objects have at least a type, name and description attribute. Content objects may also have a number ranging from 0 to N of other representative attributes. For example, a product object is described as follows:

Type: Product

Name: ABC Detergent

Description: ABC Detergent Stain Release is supercharged with specially formulated ingredients to help remove 99% of everyday stains, including greasy food stains. It also boasts the innovative “Zap! Cap,” a unique pretreat cap with scrubbing bristles to provide a deep-down, pre-treat option. The cap features two textures; bristles for deep down scrubbing and a flatter portion to spread the detergent around. Put Zap! Cap to work for you with ABC Detergent Stain Release—even the cap fights stains

Price: $25

Content experiences and content objects are associated at a system object model level with a many-to-many relationship. This means that a content experience may have a number ranging from 1 to N content objects related thereto. One of the content objects is a primary content object.

Content Registration Interface

A fundamental behavior for the platform is that users/machines are creating content experiences and objects, and linking one or more indexed media assets to the content experiences and objects. Unless otherwise specified at when they are created, content experiences and objects are entered into a public domain group of ownership. This is a key driver of that solves two of the problems posed by implementing such as platform/system. One problem is solved by having a vast dataset of media assets and their association/linked content experiences and objects by gather via open crowdsourcing” behavior, similar to what occurs on the Wikipedia® website. Another problems solved relates to cost concerns. Cost concerns can be alleviated by allowing users who cannot, or do not, wish to pay for their media asset datasets, still have them be interactively enabled and link related content experiences and objects

Either at creation or at a later point in time, users of the system may wish to officially register content experiences, content objects, and media assets with the system. Once an item is registered, the user is granted ownership and control over the item for a registration period, for example, one year, six months, etc.

The system may allow for a variety of registration tiers, thereby providing a variable set of features depending on how much the user wishes to pay, or what features the user may need. The following provides examples of different registration scenarios.

### EXAMPLE 1

A small business owner wishes to register their business and location on the inventive system. The business is a restaurant and café. The owner possesses the following media assets: signage; menus; business cards; and advertisements. The owner creates a business/location object, and registers the object in the system. Initially, first and second media assets, signage and menus, are linked to the object. Because the owner has a single business location, the owner restricts the registration of the business content to a 10 mile radius. Later, when the owner takes out an advertisement in a local paper, the owner may return to the system and platform and add further media assets to the system. The advertisement is added as a third media asset, and a coupon is added as a fourth asset. The third and fourth media assets are linked to the object.

### EXAMPLE 2

A brand manager for a large consumer packaged goods company is managing a plurality of product brands. The company's products are distributed across the United States and internationally. The manager wishes to register content on the platform that links via the various media/marketing assets. The brand manager uploads the varying assets, e.g., hundreds of variants of product, advertisements, packaging, etc., and link to the product content profile and product webpage. Because the company's brands are distributed widely, the company registers the content in a manner that allows the content to be active and available for the entire North American continent.

Variations of the present invention will be apparent to those of ordinary skill in the art in view of the disclosure contained herein. For example, the invention may be carried out over the internet. In addition, it is to be understood that, while the invention has been described in conjunction with the preferred specific embodiments thereof, the foregoing description merely illustrates and does not limit the scope of the invention. Numerous alternatives and equivalents exist which do not depart from the invention set forth above. Other aspects, advantages, and modifications within the scope of the invention will be apparent to those skilled in the art to which the invention pertains.

All patents applications and publications mentioned herein are hereby incorporated by reference in their entireties to an extent not inconsistent with the disclosure provided above.

What is claimed is:

1. A method for building and sharing an electronic database of interactive media content among a community of users, comprising:
(a) receiving from a user an electronic submission that corresponds to an audio and/or visual media asset;
(b) extracting one or more fingerprints from the received submission to produce accompanying identifying data therefor, if any, that correspond to one or more assets of an interactive media database of known assets;
(c) storing or locating the media asset and accompanying identification data as an entry in a content repository for community search and access, thereby providing to the user interactive media content; and
(d) allowing the community to create or returning to the user one or more content objects for the entry.

2. The method of claim 1, wherein the submission comprises a portion of the audio and/or visual media asset.

3. The method of claim 1, wherein the submission comprises an entirety of audio and/or visual media asset.

4. The method of claim 1, wherein (a) comprises receiving an audio media asset submission.

5. The method of claim 4, wherein step (b) is carried out using a technique that compensates for pitch shifting that may have occurred before or during (a).

6. The method of claim 1, wherein (a) comprises receiving a visual media asset submission.

7. The method of claim 6, wherein (b) employs a technique appropriate for fingerprinting sparse text.

8. The method of claim 6, wherein (b) employs a technique appropriate for fingerprinting dense text.

9. The method of claim 1, wherein (a) and (b) are carried out in a substantially simultaneous manner.

10. The method of claim 1, wherein
(b) produces no identifying data that correspond to any asset of the database,
(c) comprises storing the submission and accompanying identification data in the content repository, and
(d) comprises allowing the community to create or edit one or more content objects for the entry.

11. The method of claim 1, wherein
(b) produces identifying data that correspond to one or more assets of the database,
(c) comprises locating the entry for the submission in the content repository, and
(d) comprises returning to the user one or more content objects for the entry.

12. The method of claim 1, further comprising (e) allowing the community to create or edit one or more content experiences that capture a collection of content objects.

13. The method of claim 11, wherein at least one content object is associated with an exclusive right to assets linked thereto.

14. The method of claim 13, wherein the exclusive right is geographical.

15. The method of claim 13, wherein the exclusive right is temporal.
